(19) United States
(12) Patent Application Publication
(10) Pub. No.: US 2009/0136211 A1
(43) Pub. Date: May 28, 2009

(54) RECORDING APPARATUS, VIDEO CAMERA AND POSITION INFORMATION MANAGEMENT METHOD

(76) Inventors: Shingo Kikukawa, Ome-shi (JP); Yoko Masuo, Iruma-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/244,173

(22) Filed: Oct. 2, 2008

(30) Foreign Application Priority Data
Nov. 28, 2007 (JP) 2007-307917

(51) Int. Cl. H04N 5/00; H04M 1/00

(52) U.S. Cl. 386/117; 455/556.1

(57) ABSTRACT

According to an embodiment of the invention, position information of a place shooting a video is embedded in an audio signal with a simple configuration. When user reproduces the video, the shooting place is readily acquired from a reproduced sound of the audio signal based on the position information of the shooting place via Internet. Therefore, an apparatus having general purpose is provided. A recording/reproducing apparatus includes a global positioning system module (hereinafter, referred to as GPS module), an orthogonal frequency modulation module (hereinafter, referred to as OFDM module) multiplexing position information from the GPS module to an audio signal from a microphone, and a recording/reproducing module recording an output audio data from the OFDM module and a video data from a camera module to a recording medium.

### CROSS-REFERENCE TO RELATED APPLICATIONS

This application is based upon and claims the benefit of priority from Japanese Patent Application No. 2007-307917, filed Nov. 28, 2007, the entire contents of which are incorporated herein by reference.

### BACKGROUND

1. Field

One embodiment of the invention relates to a recording apparatus and a video camera. For example, the invention relates to a mobile phone with a camera function, and to a recording apparatus having a digital versatile disc (DVD) and/or hard disk.

2. Description of the Related Art

Recently, it is very popular to shoot records such as travel and family events using a video camera, and to store the records in a recording medium such as a DVD, and thereafter, to view these video records. In the foregoing video viewing, the following problem arises. Specifically, user later reproduces and views the recording video shot ago and the recording video when user is traveling in various places together with others. In this case, it frequently happens that user does not know the video shooting place.

User further makes the following requirements of knowing the video shooting place. For example, user wants to know the shooting place when viewing the records of a growth of his child. In addition, user wants to know the shooting place because he desires to again go to the same place as having good memories in the travel. However, if user forgets the place, there is no means for again knowing the place except that the video shooting place is recorded using memo.

The patent document 1, Jpn. Pat. appln. KOKAI Publication No. H06-6750 discloses a technique of knowing the shooting place when user views the video. According to the technique of the patent document, a position data from a global positioning system (GPS) is converted to a PCM position data using a PCM processor. The position data is recorded to a PCM data recording area of a video tape. When user reproduces the video, the video is reproduced using a DPCM processor and a processor, and then, overlapped to a video signal using an adder so that the video signal is output to a monitor.

However, according to the foregoing technique, a video recorder and a video player must be integrated together. Specifically, in the video player, the position data is recorded to the PCM data recording area of the video tape. Thus, when user reproduces the video, the video is reproduced using a DPCM processor and a processor, and then, must be overlapped to a video signal using the adder to output the video signal to a monitor. For this reason, the position data is insignificant information to the video player having no function described above. Therefore, the technique disclosed in the foregoing patent document 1 is lack of general purpose.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of he invention and not to limit the scope of the invention.

FIG. 1A and FIG. 1B are perspective views showing the appearance of a video camera to which the invention is applied;

FIG. 2 is a block diagram showing the internal function of the video camera shown in FIG. 1;

FIG. 3 is a view to explain an application example of an apparatus to which the invention is applied;

FIG. 4 is a view to explain the operation of the apparatus according to the invention;

FIG. 5 is a flowchart to explain the operation when position information is acquired in the apparatus of the invention;

FIG. 6 is a flowchart to explain the operation when video data is edited in the apparatus of the invention;

FIG. 7 is a block diagram showing the configuration of another embodiment of the apparatus according to the invention; and

FIG. 8 is a view showing still another embodiment of the apparatus according to the invention.

### DETAILED DESCRIPTION

Various embodiments according to the invention will be described hereinafter with reference to the accompanying drawings.

One embodiment of the invention can provide the following recording/reproducing apparatus and video camera having general purpose. Specifically, position information of the place shooting a video is embedded in an audio signal with a simple configuration. When user reproduces the video, the shooting place is easily acquired from a reproduced sound of the audio signal based on the position information of the shooting place via Internet.

According to one embodiment of the invention, there are provided an orthogonal frequency modulation module (OFDM module) configured to multiplex position information from a global positioning system module (GPS module) to an audio signal from a microphone; and a recording module configured to record an output audio data from the OFDM module and a video data from a camera module to a recording medium.

In this way, the position information is multiplexed to the audio signal. Therefore, even if data of the recording medium is dubbed, the position information is added to the audio signal. Thus, the position information from a reproduced sound of the audio signal is acquired using an already-known mobile phone, and then, access to a server is made. The position information is converted to a visible map, and thereafter, user can monitor the map. Therefore, the shooting place is readily confirmed. In addition, the foregoing function is obtained with a simple configuration.

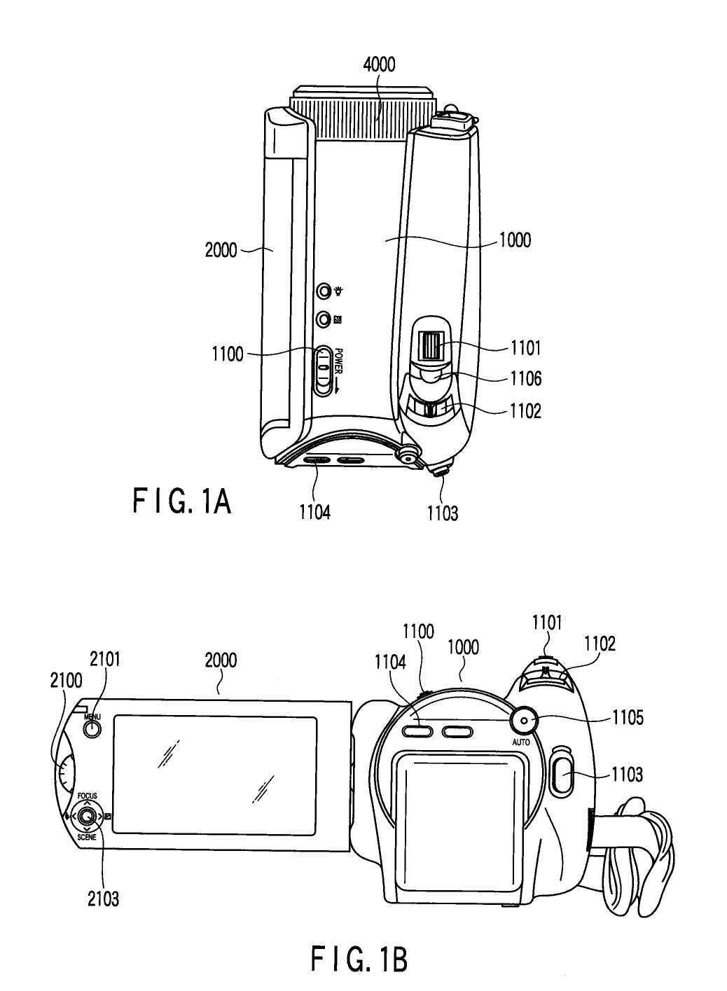

An embodiment of the invention will be hereinafter described with reference to the accompanying drawings. FIG. 1 shows the appearance of a camera to which the invention is applied, for example, a high-definition video camera. The high-definition video camera can shoot a moving image and a still image.

FIG. 1A is a perspective view showing the appearance of a high-definition video camera when being viewed from the top position. FIG. 1B is a perspective view showing the appearance of a high-definition video camera when being viewed from the backside. As shown in FIG. 1A and FIG. 1B, the high-definition video camera includes a camera body 1000, a display panel 2000 and a camera lens module 4000.

The camera body 1000 includes a power switch 1100, a zoom lever 1101, a camera/reproducing change button 1102, a camera button 1103, a chapter button 1104 and an auto setting button 1105.

The power switch 1100 changes a power state of the high-definition video camera. The zoom lever 1101 controls a focal length of a lens of the camera lens module 4000. The camera/reproducing change button 1102 changes an operation mode of the high-definition video camera to a shooting mode and a reproducing mode. The shooting mode shoots a video. The reproducing mode reproduces a stored imaging data. The camera button 1103 records a video when the operation mode of the high-definition video camera is the shooting mode. The chapter button 1104 sets a section to an imaging data. The auto setting button 1105 automatically sets various settings such as photosensitivity and brightness when shooting a video. A reference numeral 1106 denotes a still image shooting button.

The display panel 2000 is a display module of the high-definition video camera, which is attached to the camera body 1000 so that the display panel 200 is opened and closed. The display panel 2000 is usually received in a recess portion of the camera body, and opened as shown in FIG. 1B when being used. The display panel 2000 rotates around the axis of the longitudinal direction of the display panel 2000. The display panel 2000 includes a liquid crystal monitor. The liquid crystal monitor displays a video shot by the high-definition video camera, and comprises a high-definition screen having an aspect ratio 16:9. An outer frame of the display panel 2000 is provided with a jog dial 2100, a menu button 2101 and a multi-function button 2103.

The jog dial 2100 selects various functions, for example, comprises a rotatable dial. The menu button 2101 displays various menus on the liquid crystal monitor. The multi-function button 2103 includes a cross cursor key function to select various functions. For example, the cross cursor key is movable up and down and right and left. The multi-function button 2103 includes an OK button function to decide a select operation of various functions, and provided on the center of the cross cursor key. The lens module 4000 images a video, and has a camera lens receiving the video.

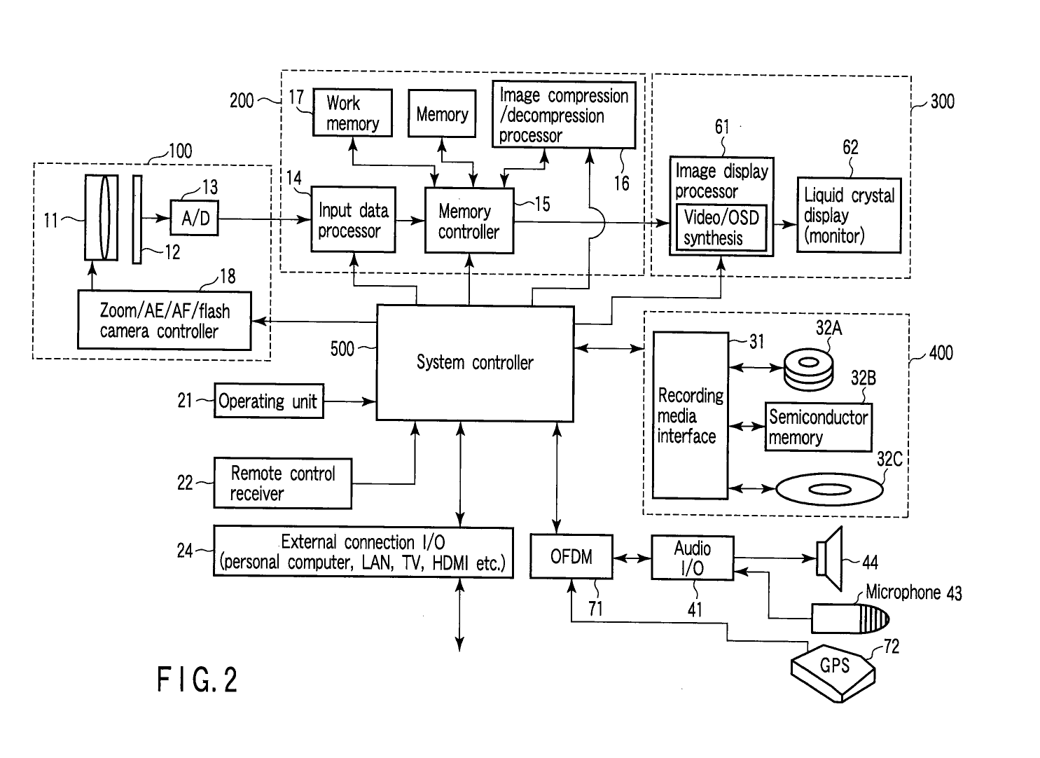

FIG. 2 is a block diagram showing an optical system and an electronic system of the high-definition video camera. The high-definition camera includes a camera module 100, a signal processor 200, a display module 300, a storage module 400 and a system controller 500.

The camera module 100 includes a lens 11, an imaging device 12, an analog-to-digital converter 13 and a camera controller 18. A subject image captured from the lens 11 is imaged on an imaging surface of the imaging device 12 (e.g., CCD imaging device). The subject image is converted to an electronic signal herein, and then, converted to a digital signal (video data) by the analog-to-digital converter 13, and thereafter, input to the post-stage signal processor 14. The camera controller 18 executes zoom control, auto-iris control (AE), auto-focus control (AF) and flash control in accordance with a control signal from the system controller 500.

The signal processor 200 includes an input data processor 14, a memory controller 15, an image encode/decode (compression/decompression) processor 16, a work memory 17 and a memory 45. The input data processor 14 executes gamma correction, color signal separation and white balance control with respect to the digital signal of the subject image from the camera module 100. When a shooting start operation is not made in a normal shooting state, the video data from the input data processor 14 is input to an image display processor 61 via the memory controller 15. When the shooting start operation is made, the image (video) compression/decompression processor 16 encodes and compresses the video data to store it in the storage module 400 (e.g., compression according to MPEG/JPEG format).

The work memory 17 is used for editing image (video) data, creating thumbnail images, and replacing the order of the image. The work memory 17 is further used for editing various icons. The work memory 17 can store image data equivalent to one screen or a plurality of screens. The video data stored in the work memory 17 is input to the image display processor 61 via the memory controller 15.

The display module 300 includes an image display processor 61 and a liquid crystal display 62. The image display processor 61 executes conversion to display the received video data on the liquid crystal display 62 and video/OSD synthesis, and then, supplies it to the liquid crystal monitor 62. According to the video/OSD synthesis, various display parts (icons, etc.) such as menu are synthesized. The liquid crystal display 62 sequentially displays the received video data. In this way, a shooting image or a subject image focused in a standby state are displayed on the liquid crystal monitor 62.

The storage module 400 includes a storage media interface (I/O) 31. The storage media interface I/O 31 has built-in storage medium such as hard disk (HDD) 32A or semiconductor memory 32B or DVD 32C. The storage medium built in the storage media I/O 31 is stored with video/audio data based on the control by the system controller 500. Based on the control by the system controller 500, the video data stored in the storage medium built in the storage media interface I/O 31 is read. In this case, the video data is decoded (decompressed) by the image compression/decompression processor 61, and thereafter, input to the image display processor 61 via the memory controller 15. In other words, a reproduced image is displayed on the liquid crystal display 62.

The system controller 500 controls the whole of the operation of the high-definition video camera. The system controller 500 is composed of CPU, buffer memory such as RAM functioning as a work area of the CPU, and program memory such as ROM stored with various programs executed by the CPU and control data. In the system controller 500, the CPU executes the programs stored in the program memory, and thereby, various functions are realized.

The high-definition video camera includes an operating module 21, a remote control receiver 22, an attitude detector 23, an external interface 24, an audio I/O 41, a microphone 43 and a speaker 44.

The high-definition video camera is connectable with a GPS module 72. The GPS module 72 may be built in the camera body. Position information from the GPS module 72 is input to the OFDM module 71, and thereafter, modulated by audio data. The audio data including the position information is converted to a recording format under the control by the system controller 500, and thereafter, recorded to a recording medium together with video data.

A terminal may be provided for connecting the OFDM module 71 to set the GPS module 72. If the terminal is provided, a set of the OFDM module 71 and the GPS module 72 can be detached or installed.

The operating module 21 receives an operation input eternally, and is a general term for various buttons or switches shown in FIG. 1. The remote control receiver 22 receives an operation input by an external remote controller (not shown). The system controller 500 controls the whole of the camera so that an operation input by the operating module 21 and the remote control receiver 22 is reflected.

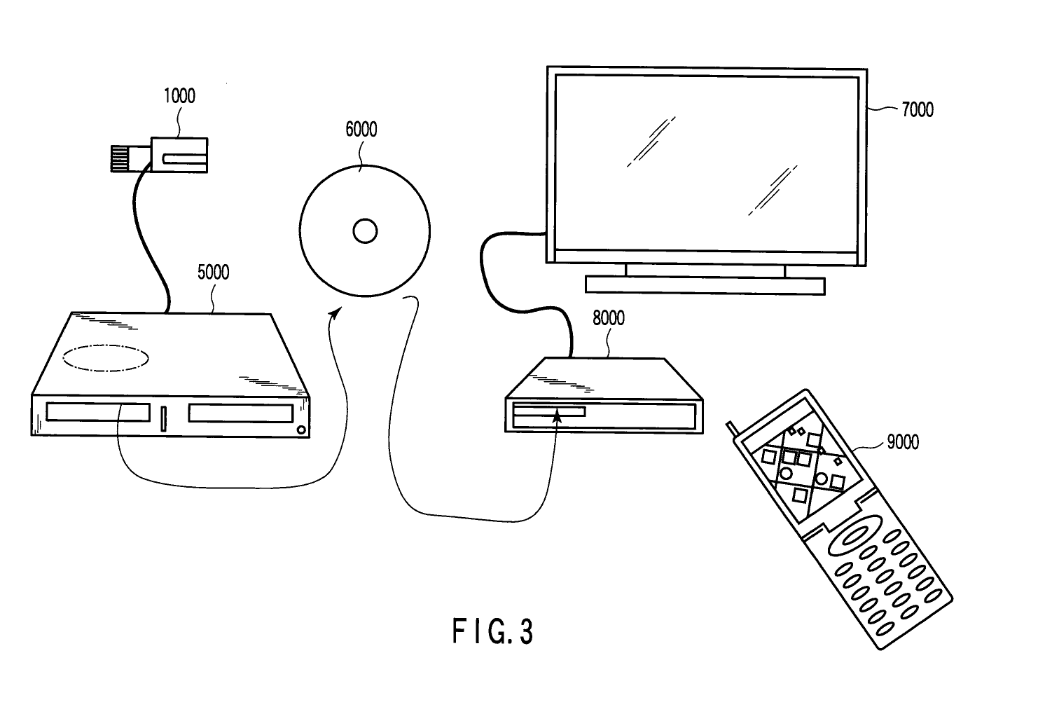

FIG. 3 is a view showing a state of dubbing an output of the foregoing high-definition video camera to a DVD 6000 using a DVD recording/reproducing apparatus 5000, and reproducing the DVD 600 using another DVD recording/reproducing apparatus 8000, and further, viewing the shooting data using a television receiver 700.

In this case, a reproduced sound includes the foregoing position information (e.g., latitude/longitude information, described as N21.16.24.55, and W157.42.00.54). The reproduced sound is collected and demodulated by a microphone of a mobile phone 9000 with an OFDM demodulation function. In this way, the mobile phone 9000 can acquire the position information. The mobile phone 9000 can receive a map service from a server based on the position information via Internet. Thus, a map display corresponding to the position information is displayed on a screen of the mobile phone 9000 with the OFDM demodulation function.

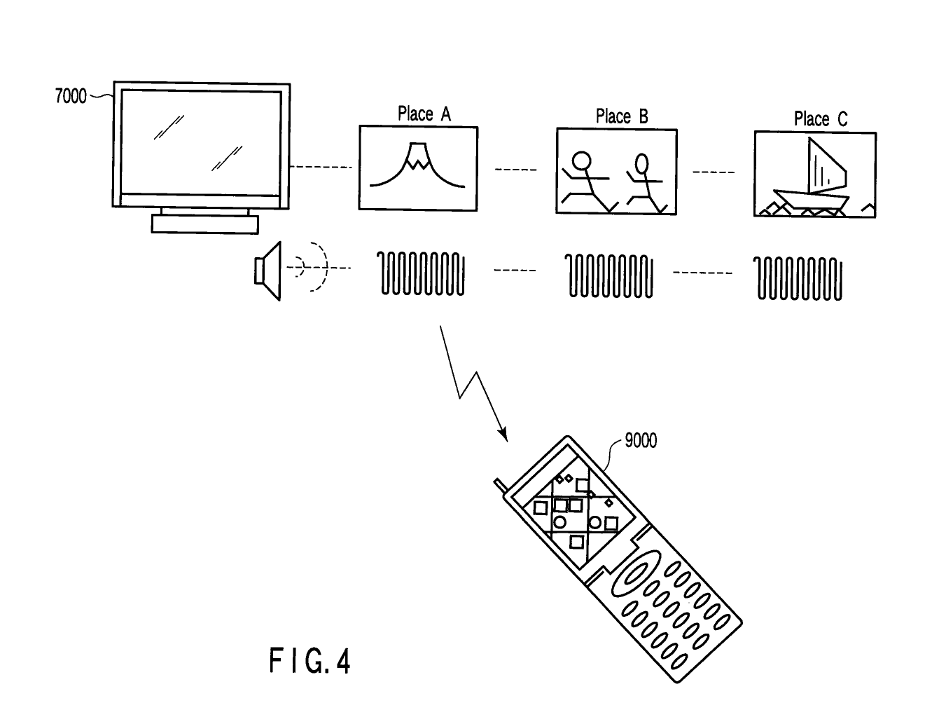

FIG. 4 is a view showing a state of images reproduced by the television receiver 7000. FIG. 4 shows a state that screens reproduced places A, B, C . . . successively change. User sees the screen of the mobile phone 9000 with the OFDM demodulation function, and thereby, can know the place of a scene now displayed on the television receiver 7000.

In the foregoing description, the mobile phone 9000 is used. In this case, any terminals may be used so long as they have the OFDM function and receive an Internet service, and therefore, the terminal is not limited to the mobile phone 9000. Acoustic OFDM technology materials can make reference to a homepage by NTT Docomo.

Video data and audio data (including position information) are stored in the recording/reproducing apparatus, and thereby, the following advantages are obtained. Specifically, if user wants to know the shooting place when viewing the following videos, user can simply and immediately know the shooting place of the reproduced screen. One is a video shot ago when user already forgets the shooting memory. Another is a video shot by user, who trusts others with a travel without knowing the place.

An apparatus for reproducing the video stored using the recording/reproducing apparatus has no need to add a special function. A general video player may be sufficiently used. In order to display the information of the shooting place on a reproduced screen, it is sufficient that a terminal enable to acoustic OFDM demodulation is provided. At present, mobile phone business firms makes technical development for including acoustic OFDM demodulation technique in the mobile phone. There is a tendency that a mobile phone enable to acoustic OFDM demodulation technique is generalized.

According to the invention, the following merits are obtained with respect to other realizing means of storing the shot video to which shooting place information is added.

The shooting place information is displayed on another terminal. Thus, the information on the shooting place is not displayed on a part of the reproduced screen viewed by user. Therefore, the reproduced screen is fully displayed without being masked by other information. (No making of reproduced screen)

When usually viewing the reproduced video, user can know the shooting place of the scene at timing when user wants to know the shooting place of the scene. (Video on demand)

Search of place related information such as place name, address, map and aerial photography corresponding to shooting position information recorded in shooting, that is, latitude/longitude information is trusted to an Internet map service. This serves to expect the advance in place related display content in accordance with the development of Internet map service technique in future. (Meet the demands of technical development)

According to a method of modulating reproduced video data so that position information data is embedded, the following problems arise. For example, when data is embedded in the whole of the reproduced video, it is difficult to capture the whole of the reproduced video using a terminal for demodulating the embedded data with an advance in a large-sized reproduction screen such as TV. In addition, when data is embedded in a part of the reproduced video, it is difficult to capture video using a terminal for demodulating the embedded data in accordance with an area where data of the reproduced screen is embedded.

On the contrary, according to the present invention, data is embedded in the reproduced sound. Thus, the reproduced sound is collected by a terminal with a data demodulator. In this way, it is possible to readily demodulate the embedded position information data.

For example, a video shooting travel and various family events by a video camera is stored. In this case, shooting position information showing where the recorded screen is shot is embedded in audio of the screen using modulation technique. In this way, when the video stored in the proposed apparatus is reproduced/viewed, user can simply know the shooting place information if user wants to know the shooting place of the reproduced screen. Therefore, the present invention serves to meet user's requirements, and to improve user's satisfaction.

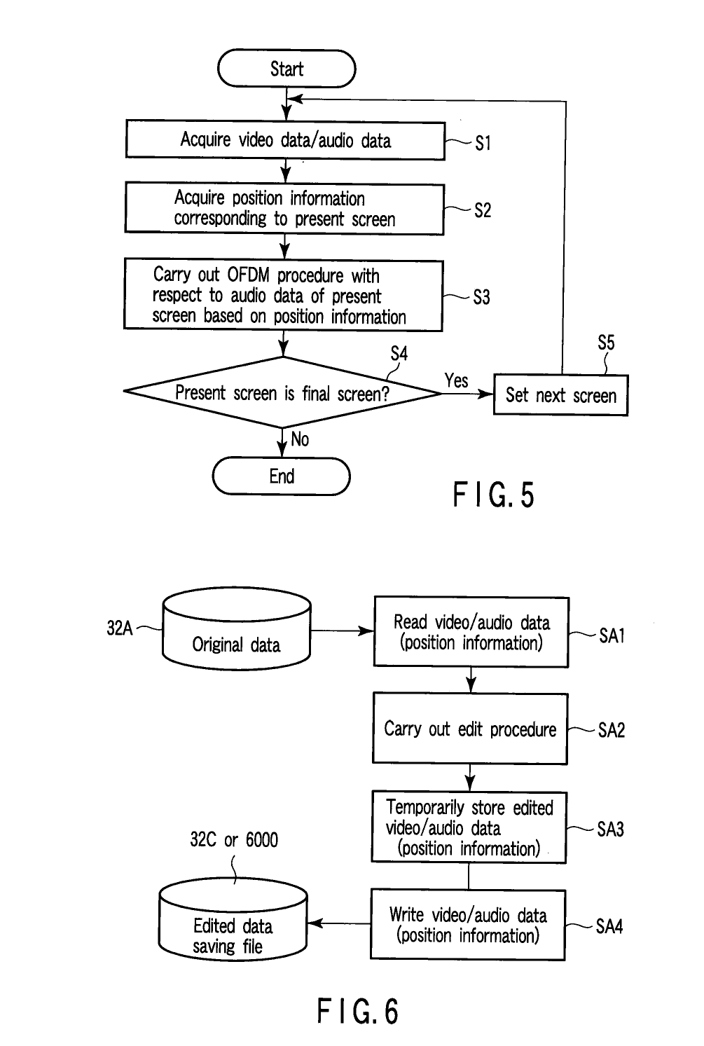

FIG. 5 is a flowchart to explain the operation procedure of acquiring shooting position information by the apparatus shown in FIG. 1 and FIG. 2. Video data and audio data are acquired in shooting, and further, position information corresponding to a screen is acquired (step S1, S2). An OFDM procedure is carried out with respect to the audio data of the present screen based on the acquired position information (step S3). Thereafter, it is determined whether or not the present screen is the final screen (step S4). If the next screen exists, the procedure related to the next screen is set (step S5). If the present screen is the final screen, the procedure ends.

FIG. 6 is a flowchart to explain the edit procedure. Video/audio data (including position information) is read from a recording medium 32A (step SA1). Thereafter, an edit procedure is carried out (step SA2). The edited video/audio data is once stored in the work memory (step SA3). Then, the edited video/audio data is written to a recording medium 32C or 6000 (step SA4).

Even if the foregoing edit procedure is carried out, the position information is embedded in the audio data. Thus, there is no need of newly providing a special processing function, and in addition, the position information is added to the edited audio data.

The foregoing description shows the embodiment in which the present invention is applied to a video camera. The present invention is applicable to a mobile phone.

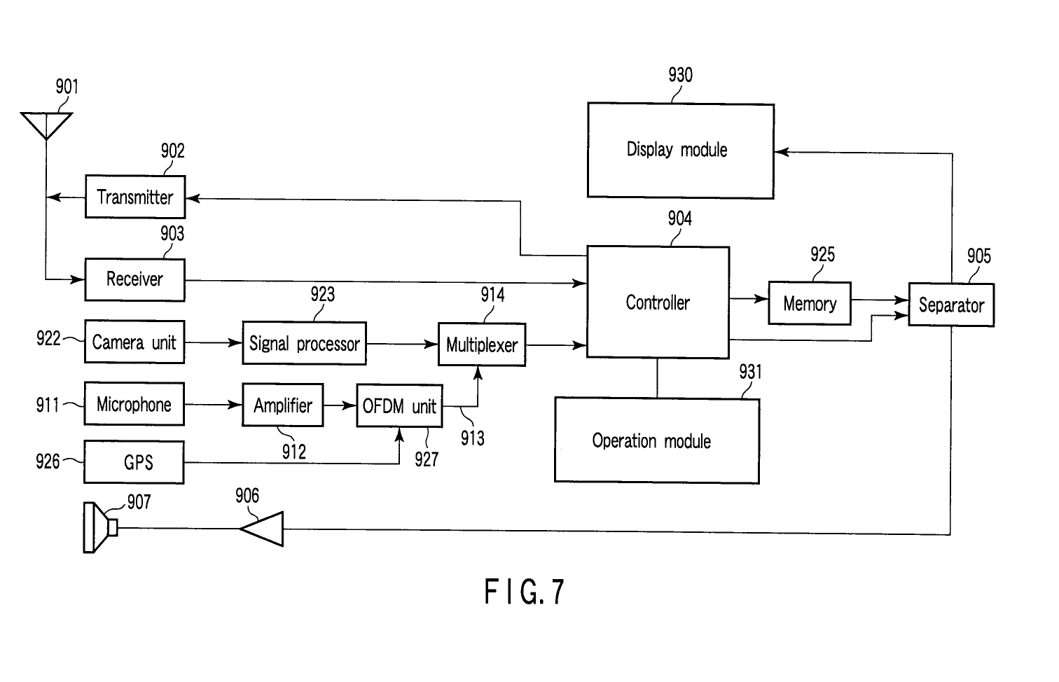

FIG. 7 is a block diagram showing the configuration of a mobile phone to which the present invention is applied. When a normal telephone function is used, an operation module 931 inputs a telephone number. A controller 904 sends the telephone number via a transmitter 902 and an antenna 901. When sending an electromagnetic wave from a communication person is received via the antenna 901 and a receiver 903, a communication line is formed. The Voice of the communication person is output from a speaker 903 via the controller 904, a separator 905 and an amplifier 906. An audio signal picked-up by a microphone 911 is input to the controller 904 via an amplifier 912, OFDM module 927 and multiplexer 914. The audio signal output from the controller 904 is modulated to a transmission frequency by the transmitter 902, and thereafter, sent from the antenna 901.

When the foregoing usual conversation is made, the OFDM module executes settings so that position information from the GPS module is not modulated by the audio signal.

When the mobile phone is in a shooting mode, an image (video) shot by a camera 922 is handled by a signal processor 923, and then, the multiplexer 914 multiplexes with the audio signal. In this case, the position information from the GPS module 926 is multiplexed to the voice signal. Further, in this case, video data/audio data (including position information) is stored in a memory 925 by the controller 904.

When the video data/audio data (including position information) stored in the memory 925 is reproduced, the video data/audio data (including position information) is read based on the control by the controller 904. Thereafter, the video data is separated by the separator 905, and then, input to and displayed on a display 930. The audio data is separated by the separator 905, and then, output as a voice from the speaker 907 via the amplifier 906.

When the controller 904 stores the video data/audio data in the memory 925, the video data/audio data is encoded and compressed according to an MPEG format, and thereafter, stored therein. The separator 905 includes a compressed video data demodulator and a compressed audio data demodulator.

In the foregoing mobile phone, when the video data/audio data read from the memory 925 is reproduced, the position information is included in the audio data. The mobile phone can receive a map service based on position information via Internet. In this way, a map display corresponding to the position information is displayed on a screen of the mobile phone 9000. In this case, reproduced video display and map information display are set so that they are changeable.

An attachment may be attached to the video camera to carry out the present invention.

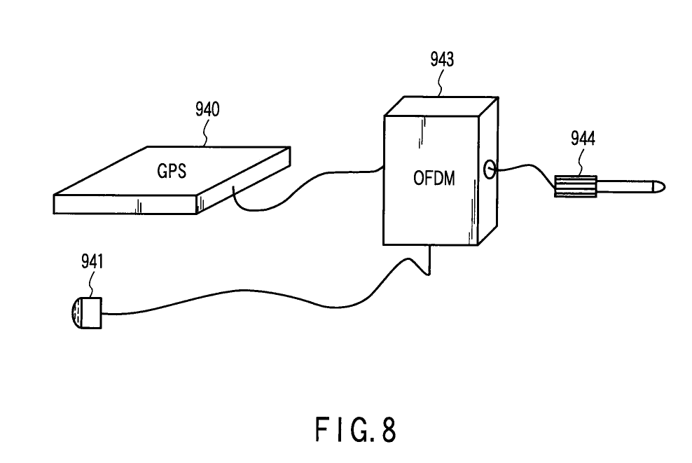

FIG. 8 is a view showing a state that an OFDM module 943 is connected with a GPS module 940 and a microphone 941. An output of the OFDM module 943 is output to a connection terminal 944. Therefore, the connection terminal 944 is connected to an audio input terminal of a conventional video camera, and thereby, the configuration of the present invention functions.

The present invention is not limited to the foregoing embodiment. Constituent components may be modified and embodied within a scope without departing from the subject matter of the invention in the inventive step. A plurality of constituent components disclosed in the foregoing embodiment is properly combined, and thereby, various inventions may be formed. For example, some constituent components may be deleted from all constituent components disclosed in the embodiment. Constituent components related to different embodiment may be properly combined.

While certain embodiments of the invention have been described, these embodiments have been presented b way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

The various module of the systems described herein can be implemented as software applications, hardware and/or software modules, or components on one of more computers, such as servers. While the various modules are illustrated separately, they may share some or all of the same underlying logic or code.

What is claimed is:

1. A recording apparatus comprising:
an orthogonal frequency modulation module (OFDM module) configured to multiplex position information from a global positioning system module (GPS module) to an audio signal from a microphone; and
a recording module configured to record an output audio data from the OFDM module and a video data from a camera module to a recording medium.

2. The recording apparatus according to claim 1, wherein
when said audio data is reproduced, a terminal obtains data of a map corresponding to the position information related to the video data from a server, and the map is displayed on the screen of the terminal.

3. The recording apparatus according to claim 1, wherein
when said audio data is reproduce from the recording medium which is drove by a reproducing apparatus, a terminal obtains data of a map corresponding to the position information related to the video data from a server, and the map is displayed on a screen of the terminal.

4. The recording apparatus according to claim 2 or 3, the terminal is a mobile phone.

5. The recording apparatus according to claim 1, wherein the position information is transferred to other recording medium simultaneously with the audio data, when the recorded video data and the recorded audio data on said recording medium are transferred to the other recording medium.

6. The recording apparatus according to claim 1, wherein the recording module is provided into one of video camera and a mobile phone.

7. A video camera comprising:
a signal processor configured to encode and decode a video data shot by a camera module;
a microphone configure to obtain an audio signal;
a global positioning system module (GPS module) configured to obtain position information;
an orthogonal frequency modulation module (OFDM module) configured to multiplex the position information to said audio signal; and
a storage module configured to store a encoded video data form the signal processor together with an output audio data from the OFDM module.

8. The video camera according to claim 7, wherein further comprising: a terminal which is connected said OFDM module to set the GPS module.

9. A shooting position information management method comprising:
multiplexing position information from a global positioning system module (GPS module) and an audio signal from a microphone using an orthogonal frequency modulation module (OFDM module);
recording an output audio data from the OFDM module and a video data from the camera module on a recording medium which is drove by a recording/reproducing module.
